(19) United States
(12) Patent Application Publication
(10) Pub. No.: US 2026/0196559 A1
(43) Pub. Date: Jul. 9, 2026

(54) Lithium Difluoro(oxolato)borate Based Localized High-Concentration Electrolyte for Lithium Metal Based Battery

(71) Applicant: GM Global Technology Operations LLC, Detroit, MI (US)

(72) Inventors: Xin Zhang, Shanghai (CN); Haijing Liu, Shanghai (CN)

(21) Appl. No.: 19/032,982

(22) Filed: Jan. 21, 2025

(30) Foreign Application Priority Data
Jan. 7, 2025 (CN) 202510020618.2

(51) Int. Cl. H01M 10/0567; B60L 50/60; H01M 4/58; H01M 4/66; H01M 10/0525; H01M 10/0568; H01M 10/0569

(52) U.S. Cl. CPC H01M 10/0567; B60L 50/60; H01M 4/5825; H01M 4/661; H01M 10/0525; H01M 10/0568; H01M 10/0569; H01M 2220/20; H01M 2300/0034

(57) ABSTRACT

An electrolyte, a battery cell for a vehicle including the electrolyte, and a method of forming the electrolyte. The electrolyte includes a solution of lithium difluoro (oxalato) borate, a solvent, and a diluent. The lithium difluoro (oxalato) borate is present at a molar ratio of 1, the solvent is present at a molar ratio in the range of 1 to 3 and the diluent is present at a molar ratio in the range of 1 to 6.

### BACKGROUND

Electric and hybrid electric vehicle technology is enabled by the development and deployment of rechargeable, secondary batteries, which provide energy to the vehicle powertrain. Secondary batteries include lithium ion batteries, which generally include a cathode, anode, separator, and electrolyte. The cathode provides the source of lithium ions and determines the capacity and average voltage of a battery. The anode stores and releases lithium ions received from the cathode when energy is needed, the separator prevents the cathode and anode from contacting and shorting out the battery, and the electrolyte provides a medium between the cathode and anode through which the lithium ions travel.

Battery performance may be quantified by a number of properties including energy density, power density, specific energy, specific power, charge rate, discharge rate, capacity decay, cycle life, thermal performance, and aging. Of particular interest is the stability of battery components, i.e., the cathode, anode, electrolyte and the current collectors, as the battery ages and experiences charge-discharge cycles. High concentration electrolytes exhibit relatively higher ion transfer numbers and improved thermal stability compared to traditional electrolytes. High concentration electrolytes often include salt concentrations that exceed 2 Molarity (M), whereas traditional electrolytes include salt concentrations of 1 Molarity (M) or less. However, high concentration electrolytes have been found to exhibit relatively high viscosity and poor wettability, which may negatively impact battery performance.

Thus, while present electrolyte chemistries and other battery materials achieve their intended purpose, there is a need for new and improved electrolyte chemistries that offer relatively improved charging rate and other performance metrics.

### SUMMARY

According to various aspects, the present disclosure relates to an electrolyte for a lithium battery cell. The electrolyte includes a solution of lithium difluoro (oxalato) borate, a solvent, and a diluent, wherein the solvent exhibits the following formula:

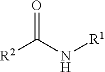

wherein R1 and R2 are individually at least one of a C1 through C4 alkyl and a C1 through C4 fluoroalkyl, and the diluent is at least one of i) a fluorinated ether exhibiting the following formula:

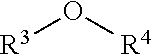

wherein R3 and R4 are individually a C2 through C3 fluoroalkyl, and ii) a fluorinated ortho ester exhibiting the following formula:

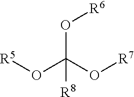

wherein R5, R6, and R7 are individually a C1 through C2 fluoroalkyl and R8 is a hydrogen. The lithium difluoro (oxalato) borate is present at a molar ratio of 1, the solvent is present at a molar ratio in the range of 1 to 3 and the diluent is present at a molar ratio in the range of 1 to 6.

In embodiments of the above, the solvent is N-methyl-2,2,2-trifluoroacetamide. In further embodiments, the solvent present at a molar ratio of 2.

In any of the above embodiments, the diluent includes 1,1,2,2,-tetrafluoroethyl-2,2,3,3,-tetrafluorpropyl ether. In further embodiments, the diluent is present at a molar ratio in the range of 2 to 4. Alternatively, or additionally, the diluent includes bis(2,2,2-trifluoroethyl) ether. Alternatively, or additionally, the diluent includes tris(2,2,2-trifluoroethyl) orthoformate.

In embodiments of the above, the solvent is N-methyl-2,2,2-trifluoroacetamide and the N-methyl-2,2,2-trifluoroacetamide is present at a molar ratio of 2 and the diluent is 1,1,2,2,-tetrafluoroethyl-2,2,3,3,-tetrafluorpropyl ether and the 1,1,2,2,-tetrafluoroethyl-2,2,3,3,-tetrafluorpropyl ether is present at a molar ratio of 4.

According to various aspects, the present disclosure relates to battery cell for a vehicle. The battery cell includes a cathode electrode including a cathode disposed on a cathode current collector and an anode electrode including an anode disposed on an anode current collector. The battery cell also includes a separator positioned between the cathode and the anode. In addition, the battery cell includes an electrolyte contacting the cathode, anode, and separator. The electrolyte includes a solution of lithium difluoro (oxalato) borate, a solvent, and a diluent, wherein the solvent exhibits the following formula:

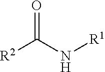

wherein R1 and R2 are individually at least one of a C1 through C4 alkyl group and a C1 through C4 fluoroalkyl group, and the diluent is at least one of i) a fluorinated ether exhibiting the following formula:

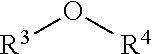

wherein R3 and R4 are individually a C2 through C3 fluoroalkyl group, and ii) a fluorinated ortho ester exhibiting the following formula:

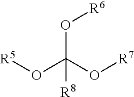

wherein R5, R6, and R7 are individually a C1 through C2 fluoroalkyl and R8 is a hydrogen. The lithium difluoro (oxalato) borate is present at a molar ratio of 1, the solvent is present at a molar ratio in the range of 1 to 3 and the diluent is present at a molar ratio in the range of 1 to 6.

In embodiments of the above, the cathode current collector includes aluminum and the anode current collector is copper.

In any of the above embodiments, the cathode is at least one of lithium iron phosphate, lithium nickel manganese cobalt oxides, lithium nickel cobalt manganese aluminum oxide, and lithium manganese iron phosphate.

In any of the above embodiments, the anode includes lithium present in the range of greater than 50 percent by weight to 100 percent by weight of the total weight of the anode and is at least one of lithium, lithium-aluminum, lithium-silver, and lithium-silicon.

In any of the above embodiments, the solvent is N-methyl-2,2,2-trifluoroacetamide. In further embodiments, the solvent present at a molar ratio of 2.

In any the diluent includes 1,1,2,2,-tetrafluoroethyl-2,2,3,3,-tetrafluorpropyl ether. In further embodiments, the diluent is present at a molar ratio in the range of 2 to 4. Additionally or alternatively, the diluent includes bis(2,2,2-trifluoroethyl) ether. Additionally or alternatively, the diluent includes tris(2,2,2-trifluoroethyl) orthoformate.

In embodiments of the above, the solvent is N-methyl-2,2,2-trifluoroacetamide and the N-methyl-2,2,2-trifluoroacetamide is present at a molar ratio of 2 and the diluent is 1,1,2,2,-tetrafluoroethyl-2,2,3,3,-tetrafluorpropyl ether and the 1,1,2,2,-tetrafluoroethyl-2,2,3,3,-tetrafluorpropyl ether is present at a molar ratio of 4.

According to various aspects, the present disclosure relates to a method of forming an electrolyte for a lithium battery cell. The method includes mixing lithium difluoro (oxalato) borate, a solvent, and a diluent. The solvent exhibits the following formula:

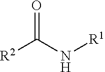

wherein R1 and R2 are individually at least one of a C1 through C4 alkyl and a C1 through C4 fluoroalkyl, and the diluent is at least one of i) a fluorinated ether exhibiting the following formula:

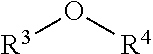

wherein R3 and R4 are individually a C2 through C3 fluoroalkyl, and ii) a fluorinated ortho ester exhibiting the following formula:

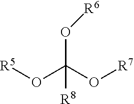

wherein R5, R6, and R7 are individually a C1 through C2 fluoroalkyl and R8 is a hydrogen, and
wherein the lithium difluoro (oxalato) borate is present at a molar ratio of 1, the solvent is present at a molar ratio in the range of 1 to 3 and the diluent is present at a molar ratio in the range of 1 to 6.

### BRIEF DESCRIPTION OF DRAWINGS

The drawings described herein are for illustration purposes only and are not intended to limit the scope of the present disclosure in any way.

FIG. 1 illustrates a vehicle and a power train including a secondary battery according to embodiments of the present disclosure.

FIG. 2A illustrates a battery according to embodiments of the present disclosure.

FIG. 2B illustrates a pouch or prismatic battery cell according to embodiments of the present disclosure.

FIG. 2C illustrates a cylindrical battery cell according to embodiments of the present disclosure.

FIG. 2D illustrates a coin battery cell according to embodiments of the present disclosure.

FIG. 3 illustrates a method of forming a battery cell according to embodiments of the present disclosure.

FIG. 4 illustrates a graph of formation voltage (V) illustrated on the vertical, y-axis and specific capacity (milliamp-hour per gram) illustrated on the horizontal, x-axis for two battery cells during formation.

FIG. 5 illustrates capacity retention percentage on the vertical, y-axis as a function of cycle number on the horizontal x, axis for two battery cells.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several embodiments and examples of the disclosure that are illustrated in accompanying drawings. Whenever possible, the same or similar reference numerals are used in the drawings and the description to refer to the same or like parts or steps. The drawings are in simplified form and are not to precise scale.

The present disclosure is related to an electrolyte for a lithium battery cell, and in particular embodiments a localized high-concentration electrolyte, a battery cell for a vehicle including the electrolyte, and a method of forming the electrolyte, as well as a method of forming a solid-electrolyte interphase film on the anode electrode. A localized high concentration electrolyte is understood as an electrolyte that includes salt concentrations that exceed 2 Molarity (M). The battery cells include any battery cell platform such as prismatic, pouch, cylindrical, or coin style battery cells. The batteries may be used in electric or hybrid-electric vehicles.

As used herein, the term “vehicle” is not limited to automobiles. While the present technology is described primarily herein in connection with electric and hybrid-electric vehicles, the technology is not limited to electric and hybrid-electric vehicles. The concepts can be used in a wide variety of applications, such as in connection with components used in motorcycles, mopeds, locomotives, aircraft, marine craft, and other vehicles, as well as in other applications utilizing batteries, such as consumer electronics, power banks for buildings, and portable power stations used for powering remote job sites, emergency back-up power supplies, and permanent power stations associated with buildings and equipment, all of which may be powered by, for example, solar or wind-powered generator systems, power mains, and fuel based power generators such as gasoline, propane, kerosene, or diesel generators as well as sterling engines.

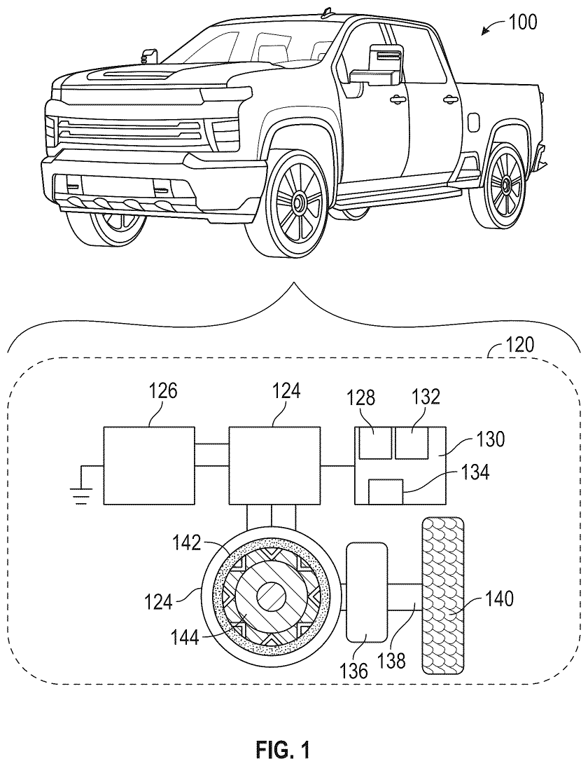

FIG. 1 illustrates a vehicle 100 including a propulsion system 120. The propulsion system 120 generally includes an electric motor 124 and a secondary battery 126 for powering the electric motor 124. Further, in many embodiments, the propulsion system 120 includes an inverter 128 for changing power from DC (direct current) as provided by the battery 126 to AC (alternating current) as it is used by the electric motor 124. The inverter 128 may be included in a power electronics module 130, which includes e.g., transistors and diodes, for switching the power from DC to AC and vice versa.

A controller 132 is connected to the inverter 128 and is programmed to control and manage the operations of the electric motor 124 and associated hardware, including the inverter 128. The electric motor 124 is connected to a transmission (drive unit) 136, and drive line 138, which transfers mechanical power and rotation to the wheels 140 of the vehicle 100. The controller 132 includes one or more one or more processors and tangible, non-transitory memory 134. A combustible fuel powered engine may also be included in the propulsion system of hybrid-electric vehicles.

With reference again to the electric motor 124, the electric motor 124, powered by the battery 126, includes a stator 142 and a rotor 144 arranged within the stator 142. The stator 142 is the stationary part of the electric motor 124. The stator 142 provides a rotating magnetic field with which the stationary magnetic field of the rotor 144 tries to align with, causing the rotor 144 to rotate, in what may be referred to as “motoring” mode. In other applications the rotating field (as caused by physical rotation) of the rotor 144 generates an electric current in the stator 142—this mode of operation is referred to as “generation” and the electric motor 124 used in this way is referred to as generator. In traction motor vehicle applications, the motoring mode provides motion to the vehicle 100. Generation mode takes some of the energy recovered from braking when the vehicle is in the process of stopping and stores it back in the vehicle battery 126.

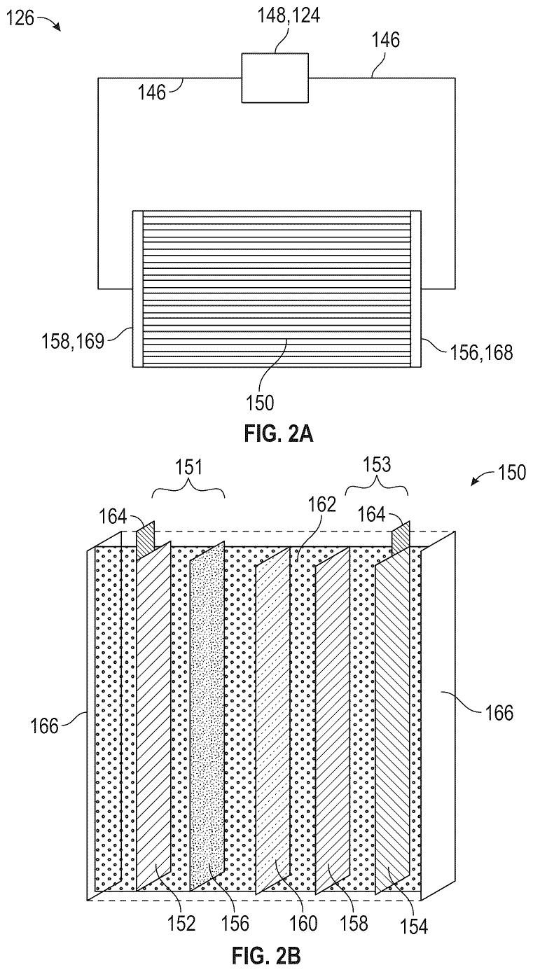

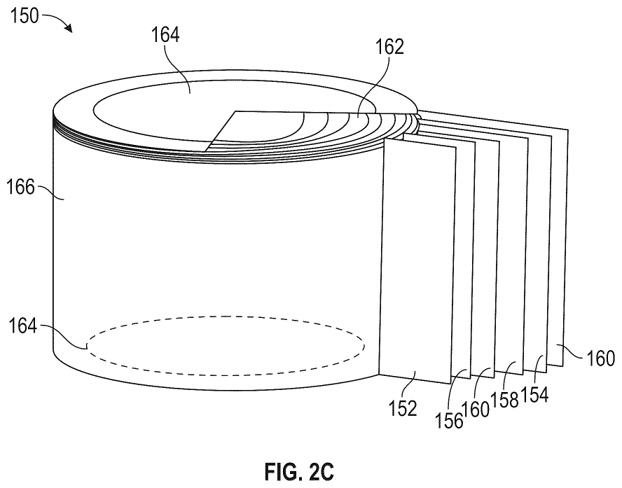

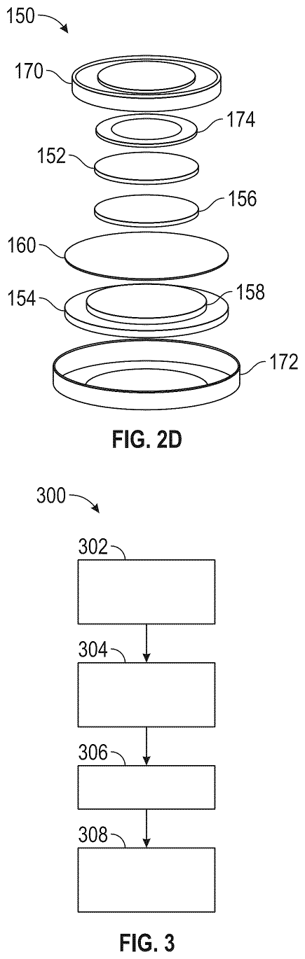

Reference is made to FIG. 2A illustrating an example of a secondary battery 126 for powering an electric vehicle 100, such as the electric vehicle 100 illustrated in FIG. 1. As noted above, secondary batteries 126 are understood as rechargeable batteries, that may be discharged upon application of a load and recharged upon the application of an external power source. Referring to FIGS. 2A, 2B, 2C, and 2D, a battery 126 is illustrated as being connected to a load 148, such as the electric motor 124. However, other loads 148 include various systems in the vehicle 100 such as climate control systems and infotainment systems. The battery 126 includes one or more battery cells 150, that are assembled together. The battery cells 150 may be, for example, pouch style, prismatic, cylindrical, or coin style battery cells, which are discussed further below. With reference to FIGS. 2B through 2D, when a load 148 is applied to the battery 126, Li+ ions move from the anode 158 to the cathode 156 through the separator 160 by way of the electrolyte 162 in each battery cell 150. Equivalent electrons e-move through the circuitry 146 from the cathode 156 to the anode 158, providing voltage to the load 148. While charging, upon application of an external voltage, Li+ ions move from the cathode 156 to the anode 158 by way of the electrolyte 162 through the separator 160 and may be intercalated into the anode 158.

Each battery cell 150, such as those illustrated in FIGS. 2B, 2C, and 2D, generally includes a cathode electrode 151 including a cathode current collector 152 and a cathode 156 disposed on the cathode current collector 152, an anode electrode 153 including an anode current collector 154 and an anode 158 disposed on the anode current collector 154, a separator 160 positioned between the cathode 156 and anode 158, and an electrolyte 162. While the illustrated battery cells 150 include one anode 158 (and anode current collector 154) and one cathode 156 (and one cathode current collector 152), the battery cell 150 may alternatively include two or more cathodes 156 (and one or more cathode current collectors 152) and one or more anodes 158 (and one or more anode current collectors 154). In further alternative embodiments, the battery cell 150 may include or one or more cathodes 156 (and one or more cathode current collectors 152) and two or more anodes 158 (and two or more anode current collectors 154). In any of the designs above, one or more separators 160 are interleaved between the cathodes 156 and anodes 158 to prevent the cathodes 156 and the anodes 158 from contacting.

In embodiments, the battery cell 150 of FIG. 2B is configured as a pouch style battery cell or as a prismatic battery cell. In either design, where multiple cathodes 156 and multiple anodes 158 are present, separators 160 are provided between the cathodes 156 and anodes 158. In embodiments, a ribbon shaped separator 160 may be z-folded around each cathode 156 (and cathode current collector 152) and around each anode 158 (and anode current collector 154). In a pouch style cell, tabs 164 are welded to the cathode current collectors 152 and the anode current collectors 154. Alternatively, the tabs 164 are formed integrally with the cathode current collectors 152 and anode current collectors 154 by cutting the tabs 164 with the cathode current collectors 152 and anode current collectors 154 from larger sheet stock. In addition, the covering 166 is in the form of a flexible film pouch formed of aluminum or another material. Prismatic style cells, on the other hand, include terminals that the cathode current collectors 152 and anode current collectors 154 are connected to and the covering 166 is formed of a relatively rigid casing, typically in the form of a cuboid. The tabs 164, or terminals, connected to the cathode current collectors 152 from multiple battery cells 150 are connected together, such as by a bus bar 168 (see FIG. 2A) or other electrical connection, and the tabs 164, or terminals, connected to the anode current collectors 154 from multiple battery cells 150 are connected together, such as by a bus bar 169 (see FIG. 2A) or other electrical connection.

Alternatively, the battery cell 150 of FIG. 2C is configured as a cylinder style battery cell 150. In this design, the cathode current collector 152, anode current collector 154, cathode 156, anode 158, and one or more separators 160 are in the form of long ribbons, which are rolled into a cylinder or jelly roll. Like the prismatic cell, the covering 166 is formed of a relatively rigid casing of aluminum or another material. Tabs 164 are welded to the cathode current collector 152 and anode current collector 154. The tabs 164 connected to the cathode current collectors 152 from multiple battery cells 150 are connected together, such as by a bus bar 168 (see FIG. 2A) or other electrical connection, and the tabs 164, or terminals, connected to the anode current collectors 154 from multiple battery cells 150 are connected together, such as by a bus bar 169 (see FIG. 2A) or other electrical connection.

In alternative embodiments, the battery cell 150 is packaged in a coin cell as illustrated in FIG. 2D. In this design, the cathode current collector 152, anode current collector 154, cathode 156, anode 158, and one or more separators 160 are in the form of discs, which are sandwiched together in the coin packaging forming the covering 166, which includes a cap 170 and a can 172. A spring washer 174 may be included between the cathode current collector 152 and the cap 170. Prior to securing the cap 170 on the can 172, electrolyte 162 is added to the battery cell 150. The cap 170 includes terminals 164 for the anode 158 and cathode 156.

In the various styles of battery cells 150 noted above, the cathode current collector 152 and anode current collector 154 are formed from conductive materials. In embodiments, the cathode current collector 152 is aluminum. Alternatively, or additionally, the cathode current collector 152 includes aluminum such as aluminum composite foil of aluminum coated thermoplastic film, conductive carbon coated aluminum foil. In further alternative embodiments, the cathode current collector includes titanium. In embodiments, the anode current collector 154 includes copper. Alternatively or additionally, the anode current collector 154 may include nickel, stainless steel, and titanium. The current collectors 152, 154 are illustrated as being in the form of a foil; however, it should be appreciated that other forms may be exhibited such as mesh or foam. In embodiments, a foil cathode current collector 152 and a foil anode current collector 154 are impermeable to gas. The cathode current collector 152 exhibits a thickness in the range of 5 micrometers to 50 micrometers, including all values and ranges therein, such as in the range of 5 micrometers to 25 micrometers. The anode current collector 154 exhibits a thickness in the range of 4 micrometers to 50 micrometers, including all values and ranges therein, such as in the range of 4 micrometers to 25 micrometers.

The cathode 156 includes a source of lithium ions (Li+) and can undergo reversible insertion or intercalation of lithium ions, determining e.g., the capacity and average voltage of the battery. In embodiments, the cathode material includes lithium iron phosphate, which exhibits an olivine type structure. Additionally or alternatively, the cathode material includes lithium manganese iron phosphate also exhibiting an olivine type structure, lithium cobalt oxide, lithium nickel manganese oxides, lithium nickel manganese cobalt oxides, lithium nickel cobalt aluminum oxides, and lithium nickel cobalt manganese aluminum oxide. In embodiments, the lithium nickel manganese cobalt oxides exhibit the formula LiNiₐMn_{b}Co_{c}O₂, wherein the sum of a, b, c is 1 such as a LiNi_{0.33}Mn_{0.33}Co_{0.33}O₂ (NMC111), LiNi_{0.5}Mn_{0.3}Co_{0.2}O₂ (NMC 523), LiNi_{0.6}Mn_{0.2}Co_{0.2}O₂ (NMC 622), LiNi_{0.7}Mn_{0.2}Co_{0.1}O₂ (NMC 721), LiNi_{0.75}Mn_{0.25}O₂ (NM75), and LiNi_{0.8}Mn_{0.1}Co_{0.1}O₂ (NMC 811). It should be appreciated lithium manganese oxide, Li₂Mn₂O₄, is a spinel type cathode.

In embodiments, the cathode material is deposited on the cathode current collector 152 at a density in the range of 1.5 milliamp-hours per square centimeter to 5.5 milliamp-hours per square centimeter, including all values and ranges therein, such as from 1.7 milliamp-hours per square centimeter to 3.5 milliamp-hours per square centimeter. The cathode material includes particles that exhibit a particle size (largest linear cross-section as measured by optical microscopy) in the range of 5 nanometers to 50 micrometers including all values and ranges therein. Further, in embodiments, olivine cathode particles are coated with carbon particles. The carbon particles are present in the range of 0.9 percent by weight to 4 percent by weight of the total weight of the cathode particles.

The cathode electrode 151, including both the cathode current collector 152 and the cathode 156, exhibits a thickness in the range of 10 micrometers to 500 micrometers including all values and ranges therein when the cathode material is formed on one side of the cathode current collector 152. When the cathode material is formed on both sides of the cathode current collector 152, the cathode electrode 151 exhibits a thickness in the range of 30 micrometers to 1050 micrometers including all values and ranges therein for a double sided cathode electrode, such as in the range of 205 micrometers to 500 micrometers.

The anode 158 includes materials that can undergo reversible insertion or intercalation of lithium ions at a lower electrochemical potential than the cathode 156 material, such that an electrochemical potential difference exists between the anode 158 and cathode 156. In embodiments, the anode material includes lithium present at greater than 50 percent by weight of the total weight of the anode, including all values and ranges from 51 percent by weight to 100 percent by weight lithium. In embodiments, the anode material is lithium. In additional or alternative embodiments, the anode material includes at least one of lithium-aluminum, lithium-silver, and lithium-silicon.

In embodiments, the anode 158 exhibits a thickness in the range of 10 micrometers to 550 micrometers, including all values and ranges therein. The anode 158 is applied to the anode current collector 154, forming a coating on the anode current collector 154, using a deposition process, such as a slurry based process, hot roll pressing process, extrusion or additive manufacturing. The combined anode 158 and anode current collector 154 provide the anode electrode 153.

The separator 160 is a porous material formed of an electrically insulative material that prevents the cathode 156 and anode 158 from contacting and potentially shorting out the circuit. The separator 160 is sandwiched, or at least partially enclosed, between the cathode 156 and anode 158, allowing the passage of the lithium ions and electrolyte 162 through the pores of the separator 160. The separator 160 may include one or more of a composite, a polymeric material, and a non-woven material. In embodiments, the separator includes at least one of polyethylene, polypropylene, polyamide, polytetrafluoroethylene, polyvinylidene fluoride, and polyvinyl chloride. In addition, the separator 160 may be filled, i.e., include one or more fillers dispersed therein, wherein the one or more fillers includes materials such as glass fiber, nonwoven fabrics, or woven fabrics. In additional or alternative embodiments, the separator 160 may include at least one of a thermally stable, porous polymer coating and a ceramic coating such as an alumina coating. The coating is disposed on one or more surfaces of a porous polymer film, the polymer film being selected from at least one of polyethylene and polypropylene. The separator 160 may include one or more layers, wherein each layer is formed from one or more of the materials noted above. The separator 160 may take the form of a film or a mesh, such as woven mesh or a slit film. In embodiments, the separator 160 exhibits a thickness in the range of 4 micrometers to 25 micrometers, including all values and ranges therein.

The electrolyte 162 provides a fluid medium through which lithium ions travel between the cathode 156 and anode 158 and permeates the separator 160. The electrolyte 162 generally includes a lithium salt dissolved in a solvent including a diluent. In embodiments, the electrolyte is a localized high-concentration electrolyte including greater than 1.0 Molarity (M) of lithium salt, such as greater than 2 Molarity (M). The lithium salt includes lithium difluoro (oxalato) borate (LiDFOB). The lithium difluoro (oxalato) borate is present in the solvent at a concentration (moles of salt per liter of solvent) of greater than 1.0 Molarity (M) to 4.0 M, including all values and ranges therein, such as 1.2 M, 2.0 M to 4.0 M, etc.

As noted, the lithium difluoro (oxalato) borate is combined with a solvent. In embodiments, the solvent exhibits the following formula:

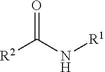

wherein R1 and R2 are individually at least one of a C1 through C4 alkyl and a C1 through C4 fluoroalkyl. Reference to C1, C2, C3, C4, etc. is reference to the number of carbons present in a given group, e.g., alkyl or fluoroalkyl, C1 indicates one carbon is present, C2 indicates 2 carbons are present, etc. In embodiments, the solvent includes N-methyl-2,2,2-trifluoroacetamide (NMTFA). In alternative embodiments, the solvent includes a derivative of a secondary amide functional group, such as N-methylacetamide, N-methylpropionamide. Without being bound to any particular theory, it is understood that the polar functional groups, i.e., the amide groups in the solvent molecules function similar to a Lewis base, increasing the solubility of the lithium difluoro (oxalato) borate, which functions similar to a Lewis acid.

A diluent is also included in the electrolyte 162. The addition of the diluent herein reduces the viscosity of the electrolyte and improves surface wettability of the electrolyte with the cathode 156. The diluent herein is also understood to improve battery cell performance during formation, i.e., the process of initially charging and discharging a battery cell to activate the materials within it. In embodiments formation occurs at temperatures in the range of 21 degrees Celsius to 50 degrees Celsius, including all values and ranges therein. Alternatively, formation may occur at temperatures of greater than 50 degrees Celsius to 80 degrees Celsius, including all values and ranges therein. The addition of the diluent herein increases the specific capacity at charge and discharge as well as the columbic efficiency over a battery cell including an electrolyte that does not include the diluents herein. In embodiments, specific charge capacities of the battery cells formed using the salt, solvents, and diluents herein are in the range of 100 milliamp-hours per gram to 300 milliamp-hours per gram, including all values and ranges therein, and specific discharge capacities are in the range of 100 milliamp-hours per gram to 300 milliamp-hours per gram, including all values and ranges therein. Further, the Columbic efficiency is greater than 90 percent, including all values and ranges therein, such in the range of 90 percent to 98 percent.

The diluent includes at least one of a fluorinated ether and a fluorinated ortho ester. The fluorinated ether exhibits the following formula:

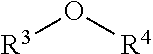

wherein R3 and R4 are individually a C2 through C3 fluoroalkyl. In embodiments, the fluorinated ether includes 1,1,2,2,-tetrafluoroethyl-2,2,3,3,-tetrafluorpropyl ether (TTE). Additionally, or alternatively, in embodiments, the fluorinated ether includes bis(2,2,2-trifluoroethyl) ether (BTFE). The fluorinated ortho ester exhibits the following formula:

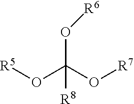

wherein R5, R6, and R7 are individually a C1 through C2 fluoroalkyl and R8 is a hydrogen. In embodiments, the fluorinated ortho ester includes tris(2,2,2-trifluoroethyl) orthoformate (TFEO).

The electrolyte is clear and transparent in nature. In embodiments, the electrolyte 162 includes lithium difluoro (oxalato) borate present at a molar ratio of 1, the solvent present at a molar ratio in the range of 1 to 5, including all values and ranges therein, and the diluent present at a molar ratio in the range of 1 to 6, including all values and ranges therein. In further embodiments, the electrolyte includes lithium difluoro (oxalato) borate present at a molar ratio of 1, the solvent present at a molar ratio of 2, and the diluent is present at a molar ratio in the range of 2 to 4. In yet further embodiments, the electrolyte 162 includes lithium difluoro (oxalato) borate present at a molar ratio of 1, N-methyl-2,2,2-trifluoroacetamide present at a molar ratio of 2 and 1,1,2,2,-tetrafluoroethyl-2,2,3,3,-tetrafluorpropyl ether present at a molar ratio of 4.

The electrolyte 162 herein, including the diluent, exhibits a viscosity in the range of 0.4 centipoise to 1 centipoise measured at room temperature (i.e., 21 degrees Celsius to 23 degrees Celsius), whereas the viscosity of an electrolyte without the diluent is in the range of 1.2 centipoise to 5 centipoise measured at room temperature. Further, the electrolyte 162 exhibits high stability relative to the lithium and relatively uniform lithium plating characteristics in forming a solid-electrolyte interphase film on the anode 158.

The electrolyte 162 is formed by mixing the lithium salt, solvent and diluent together. In embodiments, mixing occurs at room temperature under an inert atmosphere, such as nitrogen or argon gas. The electrolyte 162 may then be added to a battery cell 150, including any one of the battery cells 150 illustrated in FIGS. 2B through 2D. FIG. 3 illustrates a general method 300 of forming a battery cell 150 including the electrolyte 162. At block 302, the cathode current collector 152 with the cathode 156, the anode current collector 154 with the anode 158, and the separator 160 are assembled in a covering 166, 170, 172 to provide a battery cell 150. In embodiments, the cathode 156 is deposited onto the cathode current collector 152 prior to battery cell 150 assembly and the anode 158 is deposited onto the anode current collector 154 prior to battery cell 150 assembly. At block 304, the electrolyte 162 is added to the battery cell 150. At block 306 the battery cell 150 is sealed. In further embodiments, at block 308, the battery cell 150 is coupled to a circuit and undergoes formation. In embodiments, battery formation occurs at temperatures below 50 degrees Celsius, such as in the range of 20 degrees Celsius to 50 degrees Celsius, or alternatively at elevated temperatures from 51 degrees Celsius to 80 degrees Celsius. As noted above, during battery formation solid-electrolyte interphase films form on the anode including e.g., lithium flouride, lithium oxide, and organic lithium salts, cathode-electrolyte interphases form, and structural changes occur to the cathode and anode materials. However, corrosion of the cathode current collector is impeded, if not completely avoided, due to the addition of the electrolyte 162.

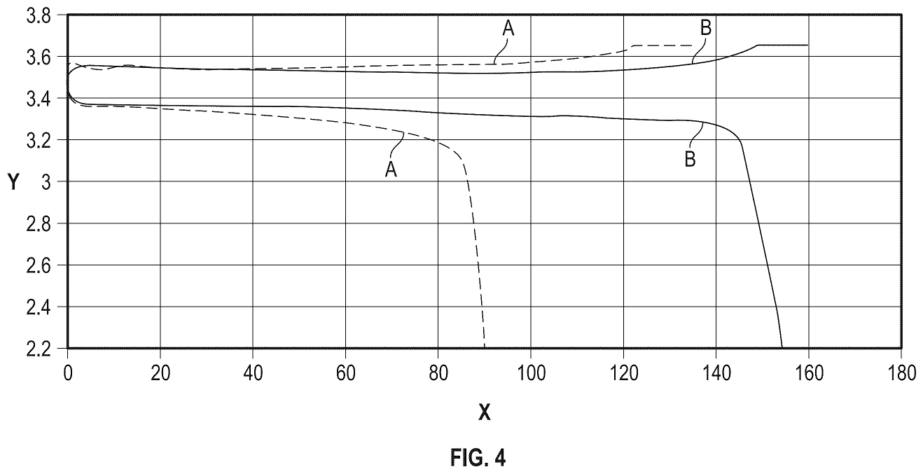

FIG. 4 illustrates a graph of voltage (V) illustrated on the vertical, y-axis and specific capacity (milliamp-hour per gram) illustrated on the horizontal, x-axis for two battery cells during formation. The first battery cell (illustrated by line A) was formed using a lithium iron phosphate cathode, an lithium anode, an aluminum cathode current collector, a copper anode current collector, and an electrolyte including lithium difluoro (oxalato) borate present at a molar ratio of 1 and N-methyl-2,2,2-trifluoroacetamide solvent present at a molar ratio of 2. The second battery cell (illustrated by line B) was formed using a lithium iron phosphate cathode, an lithium anode, an aluminum cathode current collector, a copper anode current collector, and an electrolyte including lithium difluoro (oxalato) borate present at a molar ratio of 1, N-methyl-2,2,2-trifluoroacetamide solvent present at a molar ratio of 2, and 1,1,2,2,-tetrafluoroethyl-2,2,3,3,-tetrafluorpropyl ether diluent present at a molar ratio of 4. Formation was performed at a temperature of 25 degrees Celsius and at a charge and discharge at a rate of 0.1 C (10 hours).

As can be seen, the electrolyte including the diluent (B) exhibited a significantly higher specific capacity relative to the electrolyte without the diluent (A). The electrolyte including the diluent exhibited a specific charge capacity of 159.5 milliamp-hours per gram and a specific discharge capacity of 154.8 milliamp-hours per gram. The Columbic efficiency was determined to be 97.1 percent. The electrolyte without the diluent exhibited a specific charge capacity of 134.6 milliamp-hours per gram and a specific discharge capacity of 90.2 milliamp-hours per gram. The Columbic efficiency was determined to be 67.0 percent.

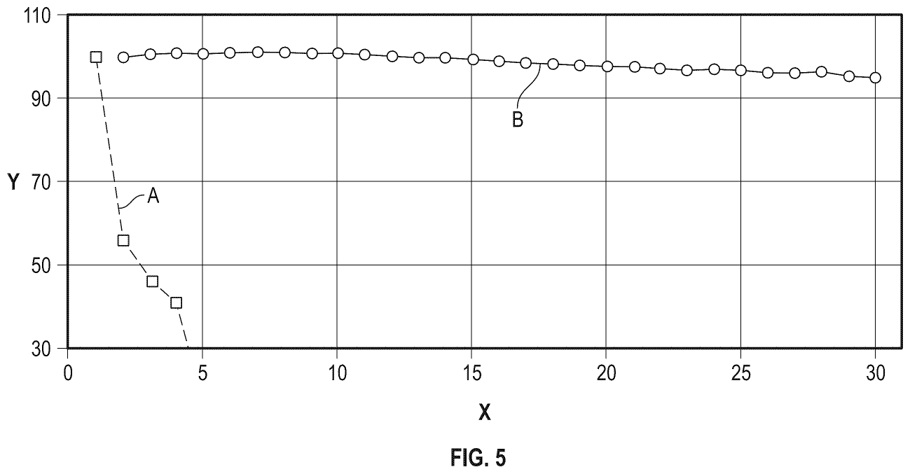

FIG. 5 illustrates capacity retention percentage on the vertical, y-axis as a function of cycle number on the horizontal x, axis for the two battery cells described above. The battery cell without the diluent, illustrated by line A, loses retention before the battery cell is run through five charge and discharge cycles. The battery cell including diluent, illustrated by line B, retains over 90 percent capacity through at least 30 charge and discharge cycles. In addition, it was observed that there was no visible aluminum corrosion on the cathode after cycling.

The electrolytes, battery cells, secondary batteries, and methods of making described herein offer a number of advantages. These advantages include, for example, preserving the benefits of localized high concentration electrolytes, including reduced viscosity, improved wettability, relatively high stability against lithium, and relatively uniform lithium plating in forming a solid-electrolyte interphase film, which provides a passivating layer on the anode electrode. The advantages also include reducing, if not completely eliminating, corrosion of aluminum in cathode current collectors seen in electrolytes that do not include the diluents disclosed herein. These advantages further include the ability to incorporate higher concentrations of lithium difluoro (oxalato) borate into the electrolyte solution.

As used herein, the term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The controller 132 may also consist of multiple controllers which are in electrical communication with each other. The controller 132 may be inter-connected with additional systems and/or controllers of the vehicle 100, allowing the controller 132 to access data such as, for example, speed, acceleration, braking, and steering angle of the vehicle 100.

A processor may be a custom made or commercially available processor, a central processing unit (CPU), a graphics processing unit (GPU), an auxiliary processor among several processors associated with the controller 132, a semi composite conductor-based microprocessor (in the form of a microchip or chip set), a macroprocessor, a combination thereof, or generally a device for executing instructions.

The tangible, non-transitory memory 134 may include volatile and nonvolatile storage in read-only memory (ROM), random-access memory (RAM), and keep-alive memory (KAM), for example. KAM is a persistent or non-volatile memory that may be used to store various operating variables while the processor is powered down. The tangible, non-transitory memory 134 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 132 to control various systems of the vehicle 100.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An electrolyte for a lithium battery cell, the electrolyte comprising:
a solution of lithium difluoro (oxalato) borate, a solvent, and a diluent,
wherein the solvent exhibits the following formula: 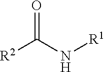
wherein R1 and R2 are individually at least one of a C1 through C4 alkyl and a C1 through C4 fluoroalkyl, and the diluent is at least one of i) a fluorinated ether exhibiting the following formula: 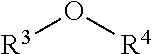
wherein R3 and R4 are individually a C2 through C3 fluoroalkyl, and ii) a fluorinated ortho ester exhibiting the following formula: 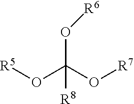
wherein R5, R6, and R7 are individually a C1 through C2 fluoroalkyl and R8 is a hydrogen, and
wherein the lithium difluoro (oxalato) borate is present at a molar ratio of 1, the solvent is present at a molar ratio in the range of 1 to 3 and the diluent is present at a molar ratio in the range of 1 to 6.

2. The electrolyte for the lithium battery cell of claim 1, wherein the solvent is N-methyl-2,2,2-trifluoroacetamide.

3. The electrolyte for the lithium battery cell of claim 2, wherein the solvent is present at a molar ratio of 2.

4. The electrolyte for the lithium battery cell of claim 1, wherein the diluent is 1,1,2,2,-tetrafluoroethyl-2,2,3,3,-tetrafluorpropyl ether.

5. The electrolyte for the lithium battery cell of claim 4, wherein the diluent is present at a molar ratio in the range of 2 to 4.

6. The electrolyte for the lithium battery cell of claim 1, wherein the diluent is bis(2,2,2-trifluoroethyl) ether.

7. The electrolyte for the lithium battery cell of claim 1, wherein the diluent is tris(2,2,2-trifluoroethyl) orthoformate.

8. The electrolyte for the lithium battery cell of claim 1, wherein the solvent is N-methyl-2,2,2-trifluoroacetamide and the N-methyl-2,2,2-trifluoroacetamide is present at a molar ratio of 2 and the diluent is 1,1,2,2,-tetrafluoroethyl-2,2,3,3,-tetrafluoropropyl ether and the 1,1,2,2,-tetrafluoroethyl-2,2,3,3,-tetrafluoropropyl ether is present at a molar ratio of 4.

9. A battery cell for a vehicle, comprising:
a cathode electrode including a cathode disposed on a cathode current collector;
an anode electrode including an anode disposed on an anode current collector;
a separator positioned between the cathode and the anode; and
an electrolyte contacting the cathode, anode, and separator, wherein the electrolyte includes:
a solution of lithium difluoro (oxalato) borate, a solvent, and a diluent,
wherein the solvent exhibits the following formula: 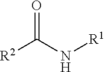
wherein R1 and R2 are individually at least one of a C1 through C4 alkyl group and a C1 through C4 fluoroalkyl group, and the diluent is at least one of i) a fluorinated ether exhibiting the following formula: 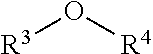
wherein R3 and R4 are individually a C2 through C3 fluoroalkyl group, and ii) a fluorinated ortho ester exhibiting the following formula: 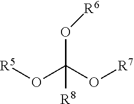
wherein R5, R6, and R7 are individually a C1 through C2 fluoroalkyl and R8 is a hydrogen, and
wherein the lithium difluoro (oxalato) borate is present at a molar ratio of 1, the solvent is present at a molar ratio in the range of 1 to 3 and the diluent is present at a molar ratio in the range of 1 to 6.

10. The battery cell for the vehicle of claim 9, wherein the cathode current collector includes aluminum and the anode current collector is copper.

11. The battery cell for a vehicle of claim 10, wherein the cathode is at least one of lithium iron phosphate, lithium nickel manganese cobalt oxides, lithium nickel cobalt manganese aluminum oxide, and lithium manganese iron phosphate.

12. The battery cell for the vehicle of claim 11, wherein the anode includes lithium present in the range of greater than 50 percent by weight to 100 percent by weight of the total weight of the anode and is at least one of lithium, lithium-aluminum, lithium-silver, and lithium-silicon.

13. The battery cell for the vehicle of claim 12, wherein the solvent is N-methyl-2,2,2-trifluoroacetamide.

14. The battery cell for the vehicle of claim 13, wherein the solvent is present at a molar ratio of 2.

15. The battery cell for the vehicle of claim 12, wherein the diluent is 1,1,2,2,-tetrafluoroethyl-2,2,3,3,-tetrafluorpropyl ether.

16. The battery cell for the vehicle of claim 15, wherein the diluent is present at a molar ratio in the range of 2 to 4.

17. The battery cell for the vehicle of claim 12, wherein the diluent is bis(2,2,2-trifluoroethyl) ether.

18. The battery cell for the vehicle of claim 12, wherein the diluent is tris(2,2,2-trifluoroethyl) orthoformate.

19. The battery cell for the vehicle of claim 12, wherein the solvent is N-methyl-2,2,2-trifluoroacetamide and the N-methyl-2,2,2-trifluoroacetamide is present at a molar ratio of 2 and the diluent is 1,1,2,2,-tetrafluoroethyl-2,2,3,3,-tetrafluoropropyl ether and the 1,1,2,2,-tetrafluoroethyl-2,2,3,3,-tetrafluoropropyl ether is present at a molar ratio of 4.

20. A method of forming an electrolyte for a lithium battery cell, comprising:
mixing lithium difluoro (oxalato) borate, a solvent, and a diluent,
wherein the solvent exhibits the following formula: 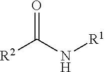
wherein R1 and R2 are individually at least one of a C1 through C4 alkyl and a C1 through C4 fluoroalkyl, and the diluent is at least one of i) a fluorinated ether exhibiting the following formula: 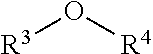
wherein R3 and R4 are individually a C2 through C3 fluoroalkyl, and ii) a fluorinated ortho ester exhibiting the following formula: 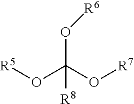
wherein R5, R6, and R7 are individually a C1 through C2 fluoroalkyl and R8 is a hydrogen, and
wherein the lithium difluoro (oxalato) borate is present at a molar ratio of 1, the solvent is present at a molar ratio in the range of 1 to 3 and the diluent is present at a molar ratio in the range of 1 to 6.
